(19) United States
(12) Patent Application Publication
(10) Pub. No.: US 2007/0228828 A1
(43) Pub. Date: Oct. 4, 2007

(54) Method to limit interference to passive start and entry systems

(75) Inventors: Gerald Ostrander, Davison, MI (US); Tejas B. Desai, Troy, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/725,172

(22) Filed: Mar. 16, 2007

Related U.S. Application Data
(60) Provisional application No. 60/782,899, filed on Mar. 16, 2006.

(51) Int. Cl. B60R 25/04; G05B 19/00

(52) U.S. Cl. 307/10.3; 340/5.64

(57) ABSTRACT

A vehicle passive start and entry system includes a controller that sends signals through a low frequency antenna to an identification device. The low frequency antenna is disposed within the vehicle cabin and proximate a source that generates extraneous electronic noise that may interfere with the transmission between the passive start and entry system and the identification device. Placing the low frequency transmitting antenna proximate these noise generating devices and locations prevents and provides for a uniform consistent and uninterrupted signal between the passive start and entry system and the identification device.

### CROSS REFERENCE TO RELATED APPLICATION

The application claims priority to U.S. Provisional Application No. 60/782,899 which was filed on Mar. 16, 2006.

### BACKGROUND OF THE INVENTION

This invention generally relates to method and system for improving operation of a passive start and entry system. More particularly, this invention relates to a method and system for overcoming electronic interference generated by accessory device power sources and chargers.

A passive start and entry system utilizes communication from an identification device carried by an operator to authorize operation of the vehicle. An increasing variety of portable electronic devices are being carried and used within a vehicle. Cell phones, personal digital assistants, music players and navigation systems are all increasingly being utilized within a vehicle. Each device is often powered by the vehicle through a plug that is inserted into an accessory outlet.

These plugs generate undesirable electronic noise that is much greater than any limits on the actual device that it is powering. Previously, such outlets were used infrequently and therefore did not present much of a problem. However, with increased use, of both portable devices and passive start and entry system, interference caused by the power sources can become a problem and interfere with use of the passive start and entry system.

Accordingly, it is desirable to design and develop a process for operating a passive start and entry system in the presence of increased electronic noise emitted from a charging device within the vehicle.

### SUMMARY OF THE INVENTION

An example passive start and entry system includes a low frequency antenna that is supported within the vehicle and proximate an accessory outlet within a motor vehicle.

The example passive start and entry system includes a controller that receives and transmits communication through a low frequency transmitting antenna. This low frequency transmitting antenna is disposed within the interior of the vehicle. The antenna within the interior of the vehicle provides for increased signal strength to overcome electronic interferences that may be generated from within the vehicle.

The transmitting antenna is disposed approximate an accessory outlet. Accessory outlets are commonly utilized to charge and power portable electronic devices that are operating within the vehicle. The charging cables or plugs that are received within the accessory outlets generate a great deal of electronic noise. This electronic noise can overcome or drown out the signals from the low frequency antenna because it is not disposed within the vehicle. The example system includes the placement of the low frequency antenna within the vehicle and more specifically adjacent accessory outlets such that the transmission signal from the passive start and entry system will overcome any electronic interference generated from devices mounted or utilized within the vehicle.

Accordingly, the passive start and entry system includes a transmitting antenna disposed within the vehicle cabin to overcome electronic interferences generated by other electronic devices.

These and other features of the present invention can be best understood from the following specification and drawings, the following of which is a brief description.

### BRIEF DESCRIPTION OF THE DRAWINGS

FIG. 1 is a schematic representation of the example passive start and entry system.

### DETAILED DESCRIPTION OF THE PREFERRED EMBODIMENT

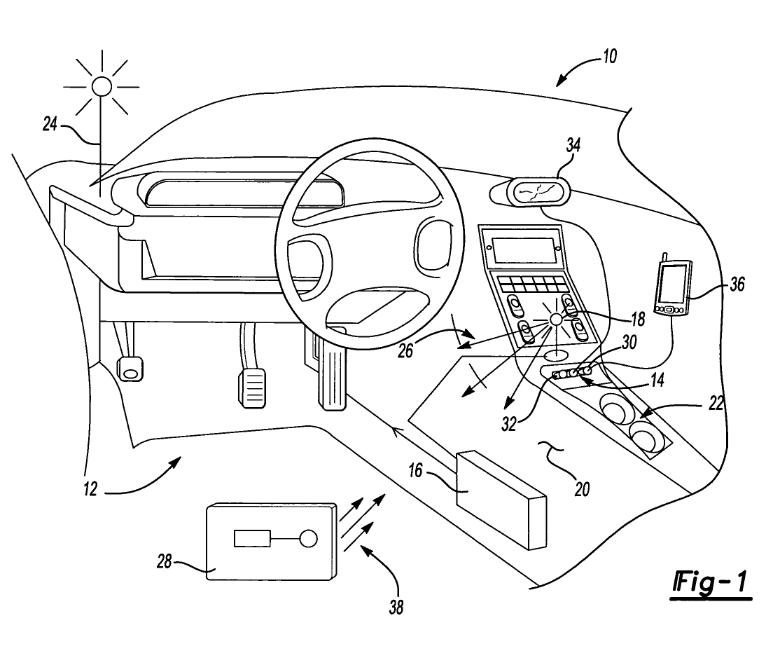

Referring to FIG. 1, a motor vehicle 10 includes an interior cabin 12. The interior cabin 12 includes accessory outlets 14. The accessory outlets 14 were commonly included in vehicles to power a cigarette lighter, but are now included to power portable electronic devices. For example, such devices include GPS navigation device 34, portable music players and personal digital assistants (PDA) 36, in addition to being utilized to recharge and power a cell phone.

The disclosed example illustrates the GPS navigation system 34 and the PDA 36 with plugs 30, 32 received within the accessory outlets 14. The accessory outlets 14 and the plugs 30, 32 can therefore generate a magnitude of electronic noise greater than that generated by the devices 34,36 themselves. In many instances, the degree of electronic noise generated by the accessory plugs 30, 32 is of such a magnitude that it could potentially disrupt communication between a passive start and entry system 16 and an identification card 28 or other identification device required to authorize access and operation of a vehicle.

The example passive start and entry system 16 includes a low frequency transmitting antenna 18 that is disposed proximate the accessory outlets 14. The low frequency antenna 18 transmits a prompt signal 26 that is received by the identification device 28. The identification device then responds to the prompt signal 26 with an identification signal 38. This identification signal 38 can be received by the low frequency transmitting 18 or by a second antenna 24.

The accessory outlets 14 are commonly supported within a structure of the motor vehicle that also supports other storage items such as beverage container holders 22. It is in this location that the antenna 18 is also supported. The antenna 18 is supported within the same vehicle structure that supports the accessory outlets 14 and the beverage container holders 22. This placement of the low frequency transmitting antenna 18 places the antenna proximate the source of electronic noise that causes distortion in the communication between the identification card 28 and the passive start and entry system 16. This placement allows and provides for the low frequency transmitting antenna 18 to overcome any electronic noise generated proximate the accessory outlets 14. Overcoming electronic noise proximate the accessory outlets 14 provides for the consistent and uninterrupted communication between identification device 28 and the passive start and entry system 16.

Because the electronic noise generated by the plugs within the accessory outlets is typically confined to the area proximate the accessory outlets 14, the placement of the low frequency transmitting antenna 18 close to those locations provides a desired starting point for transmissions and signals to the identification device 28. Further, as the identification device 28 is typically carried by an operator seated within the drivers seat, the distance between the identification device 28 and the low frequency antenna 18 is reduced. The reduction in distance between the low frequency antenna 18 and the identification device 28 increases received signal strength at the identification device 28.

Accordingly, placement of a low frequency antenna in a location proximate the accessory outlets within a vehicle cabin reduces and overcomes any impact caused by external noises or electronic signals generated by portable electronic devices utilized within a vehicle cabin.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A passive start and entry system for a vehicle including an accessory power outlet disposed within an interior cabin, said passive start and entry system comprising:
an electronic control unit for authorizing operation of desired functions responsive to receipt of a valid identification signal; and
a first antenna for transmitting a prompt signal disposed within the interior cabin of the vehicle.

2. The system as recited in claim 1, including an identification device capable of transmitting an identification signal responsive to said prompt signals.

3. The system as recited in claim 1, wherein said first antenna comprises a low frequency antenna.

4. The system as recited in claim 1, wherein said first antenna is disposed adjacent to the accessory outlet disposed within the interior cabin.

5. The system as recited in claim 1, including a passive identification device responsive to said prompt signal sent from said first antenna.

6. The system as recited in claim 5, including a second antenna disposed in a location different than said first antenna for receiving a signal from said passive identification device.

7. A vehicle passive start and entry system for installation within a vehicle including an accessory outlet, said system comprising:
a controller disposed within the vehicle for authenticating and operating vehicle systems responsive to receipt of a verified identification signal;
an identification device for sending an identification signal to said controller; and
a first antenna for installation within an interior compartment of the vehicle for transmitting a prompt signal to said identification device.

8. The system as recited in claim 7, wherein the first antenna is supported within a common structure that supports the accessory outlet.

9. The system as recited in claim 7, wherein the first antenna is supported adjacent the accessory outlet.

10. The system as recited in claim 7, wherein the first antenna transmits at a power greater than electronic noise generated by the accessory outlet.

11. The system as recited in claim 7, wherein the first antenna is supported within a vehicle structure that includes a holder for a beverage container.

12. A method of overcoming interference of a signal from a passive start and entry system from portable devices within a vehicle cabin, said method comprising the steps of:
a) supporting a transmitting antenna within a structure of the vehicle cabin adjacent an accessory power outlet;
b) transmitting a prompt signal from the transmitting antenna; and
c) transmitting an identification signal from an identification device disposed within the vehicle cabin responsive to the prompt signal.

13. The method as recited in claim 12, wherein the antenna is supported within the same structure supporting the accessory power outlet.

14. The method as recited in claim 12, wherein the antenna is supported within a structure including a holder for a beverage container.

15. The method as recited in claim 12, wherein the transmitting antenna transmits at a power determined to overcome noise interference generated from a power adaptor received within the accessory power outlet.
